(19) United States
(12) Patent Application Publication
(10) Pub. No.: US 2010/0173209 A1
(43) Pub. Date: Jul. 8, 2010

(54) FUEL CELL TWO-PHASE COOLANT EXIT MANIFOLD

(76) Inventors: Sundar Jayaraman, Hartford, CT (US); Robert R. Fredley, Tolland, CT (US)

Correspondence Address: M P Williams, 210 Main Street, Manchester, CT, 06042, US

(21) Appl. No.: 12/452,671

(22) PCT Filed: Jul. 18, 2007
(86) PCT No.: PCT/US07/16354

§ 371 Date: Jan. 14, 2010

(51) Int. Cl. H01M 8/04

(52) U.S. Cl. 429/428

(57) ABSTRACT

A liquid electrolyte fuel cell stack (13) includes a plurality of fuel cells (19) disposed in groups between a plurality of cooler plates (18-20), the cooler plates being connected by tubing (29) to a vertical coolant outlet manifold (27). The coolant outlet manifold has a coolant cross sectional flow area which increases from near the bottom to near the top, either by virtue of an increasing internal dimension (34-38) of the manifold or by virtue of an insert (41) which is larger at the bottom than at the top. The insert may be either a linear or rotund trianguloid, cone, conoid, pyramid or pyramoid. The internal dimension of the coolant outlet manifold or the dimension of the insert may be stepped or continuous, linear or non-linear.

### TECHNICAL FIELD

The improvement herein relates to cross sectional flow area of vertical, two-phase fuel cell coolant exit outlet manifolds which increases from the bottom of the outlet manifold to the top thereof.

### BACKGROUND ART

As shown in FIG. 1, because of the liquid, a liquid electrolyte fuel cell stack 13 is typically arranged with fuel cells 15 lying horizontally and stacked one upon the other. Temperature is controlled with a flow of coolant through cooler plates 18-20, which are interspersed with the fuel cells 15. Typically, there may be between about four and about ten fuel cells between each cooler plate 18, there being eight in the illustrative example of FIG. 1. A conventional installation includes a vertical coolant inlet manifold 22 having individual tubes 25 fluidically connecting the inlet manifold 22 with each of the cooler plates 18-20. The example of FIG. 1 includes a vertical coolant outlet (or exit) manifold 27 having individual tubes 29 fluidically connecting each of the cooler plates 18-20 with the exit manifold 27. FIG. 2 illustrates that the tube 25 corresponding to each of the cooler plates 18-20 is in fluid communication with a serpentine coolant flow path 30, which meanders back and forth and discharges the coolant through a tube 29 into the outlet manifold 27.

It is noted, for the following discussions, that because the top cooler 18 and bottom cooler 20 are near cool ambient, with fuel cells on only one side, they do not require the same mass flow as the intermediate coolers 19, and may provide adequate cooling without producing any steam at all. Because the heat of vaporization is more effective than conduction with coolant water, the interior coolers 19 will cool the fuel cells 15 in a most efficient fashion if the mass flow is controlled so that heating of the coolant by the normal operation of the fuel cells 15 will produce a small amount of steam. The amount of steam is targeted to be that which is sufficient for hydrocarbon feed reformation to produce fuel gas with a high hydrogen concentration. In the illustrative example, the amount of steam may be on the order of 3 mass percent to 10 mass percent.

In normal, electric power producing operation of a liquid electrolyte fuel cell stack, the electrolyte is evaporated into the reactant gas streams, and is condensed out of the reactant gas streams near the gas stream exits. This process is dependent upon the temperature of the fuel cells. This in turn requires careful temperature control of all of the coolant for all the cells in a stack. All of the processes in a liquid electrolyte fuel cell are dependent to various degrees on the temperature of the cell, as well as the temperature differential from the inlet of the cell to the outlet of the cell. Since the catalytic reaction of the reactants in the fuel cells generate significant heat, adequate cooling of each fuel cell is required. Fuel cell efficiency and life expectancy of the fuel cell are dependent upon fuel cell temperature as well. Coolant maldistribution will of course result in unwanted variation of fuel cell temperatures from a desired norm.

If there is significant mass flow through the coolers 18, resulting in significant pressure drops, such as on the order of 15 psig, the mass flow and therefore the coolant temperature is easily controlled by adjustment of the flow characteristics through the tubes 29. For instance, minor restrictions can reduce mass flow in some coolers 19 to thereby increase mass flow in other coolers and adjust pressure drops. However, in coolers having low mass flow, such as on the order of 70 lb/hr to 80 lb/hr, the pressure drop across the cooler may be on the order of 5 psig 8 psig. It has been found that adjustments to the tubes 29 is not effective in standardizing the coolant flow in and temperature of the cooler plates 18.

If the mass flow were all single phase (just water, and no steam), the pressure differential across the top cooler 18 would be the same as the pressure differential across the bottom cooler 20, as shown in FIG. 3. That is because the increase in pressure between the inlet pressure of the top cooler 18 and the inlet pressure of the bottom cooler 20, due to the gravity head, is offset by the difference in pressure between the outlet pressure of the top cooler 18 and the outlet pressure of the bottom cooler 20 due to the gravity head.

With a relatively large outlet manifold cross sectional area (on the order of the same cross sectional area of the inlet manifold), the lower mass of the two-phase flow in the outlet manifold results in the pressure differential between the bottom of the manifold and the top of the manifold being less than the pressure differential of the water between the bottom of the inlet manifold and the top of the inlet manifold, as is illustrated in FIG. 4. Therefore, the pressure drop across each cooler will be a function of its position, decreasingly toward the top. With different pressure drops, there will be different flows; different flows result in different heat extraction, which in turn allows the temperature of the fuel cells near the top of the stack to be progressively higher than the temperature of the fuel cells near the bottom of the stack.

### SUMMARY

The improvement herein derives from the discovery that with two-phase flow, the mass flow of coolant in a vertical manifold is not only dependent on the gravity head pressure but is also dependent on the pressure drop due to frictional losses. At the bottom of the outlet manifold 27, where the mass flow is relatively small (being from one cooler only) and there is little or no steam, the frictional pressure drop due to flow of coolant is relatively small. But the pressure drop due to frictional losses near the top of the coolant outlet manifold 27 is higher. There is a gradient of frictional pressure loss that increases from the bottom of the coolant outlet manifold 27 to the top of the coolant outlet manifold 27, but this is not necessarily a linear gradient.

In order to provide additional pressure gradient in the outlet manifold, the cross section of the manifold may be selected so that the pressure drop resulting from the frictional pressure loss due to the flow in the outlet manifold, from the bottom of the manifold toward the top of the manifold, will approximate the difference between the exit pressure shown in FIG. 4 from the exit pressure shown in FIG. 3. This is illustrated in FIG. 5, wherein the solid, curved line represents the total pressure differential due both to gravity head and to frictional forces. The compensation provided by the selected cross sectional area of the exit manifold is shown hatched in FIG. 5. However, the correction, shown in the solid, curved line to the left of FIG. 5, is non-linear, meaning that the pressure drop across coolers near the bottom and the top of the stack will be greater than the pressure drop for coolers in the center of the stack. This means that there is a curvilinear gradient in temperature of fuel cells, those in the center of the stack being the warmest.

Accordingly, the pressure drop across cooler plates and therefore the mass flow of coolant in the cooler plates of a stack are all brought within an acceptable tolerance of a desired norm as illustrated by the dotted line to the left in FIG. 5. The cross sectional flow area of a coolant outlet manifold is adjusted so that the cross sectional flow area increases from the bottom of the coolant exit manifold to the top of the coolant exit manifold. This may be achieved by having a manifold in which the diameter increases from the bottom of the manifold to the top of the manifold. Such increase can be in steps with segments of different diameter or in a continuous fashion, which may be linear or non-linear, the gradient being lesser at the bottom and greater at the top.

The improvement may also be practiced in a coolant outlet manifold which is of a uniform cross sectional flow area, but containing an insert which is larger at the bottom and smaller at the top. The insert may have a continuous change in cross sectional flow area or be stepwise; the insert may be linear or non-linear in its incremental size, and it may be rotund. The inserts may be trianguloids, cones or conoids, pyramids, pyramoids or of other shapes. The decrease in cross sectional area of such inserts may be continuous or it may decrease in steps; the decrease may be linear or non-linear; it may be rotund.

The invention corrects pressure differences resulting from frictional losses due to the steam in the flow of outlet coolant, which in turn provides substantially identical pressure drops across all of the fuel cells, from about the bottom to about the top, thereby providing mass flow and temperature within the cooler plates which are all within an acceptable tolerance of a desired norm.

### BRIEF DESCRIPTION OF THE DRAWINGS

FIG. 1 is a front elevation view of a liquid electrolyte fuel cell stack.

FIG. 2 is a partially sectioned, plan view of the stack of FIG. 1.

FIGS. 3-5 are plots illustrating coolant manifold pressures.

FIG. 6 is a sectioned side elevation view of a first embodiment of a coolant exit manifold with increasing flow cross sectional flow area as a function of height in accordance with the improvement herein.

FIG. 7 is a sectioned side elevation view with section lines omitted for clarity, of a first embodiment of an insert that increases cross sectional flow area with height in a coolant outlet manifold.

FIG. 8 is a perspective view of a trianguloid insert, with the horizontal dimension greatly exaggerated.

FIG. 9 is a perspective view of a conical insert, with the horizontal dimension greatly exaggerated.

FIG. 10 is a perspective view of a pyramidal insert, with the horizontal dimension greatly exaggerated.

FIG. 11 is a perspective view of a rotund conoid insert, with the horizontal dimension greatly exaggerated.

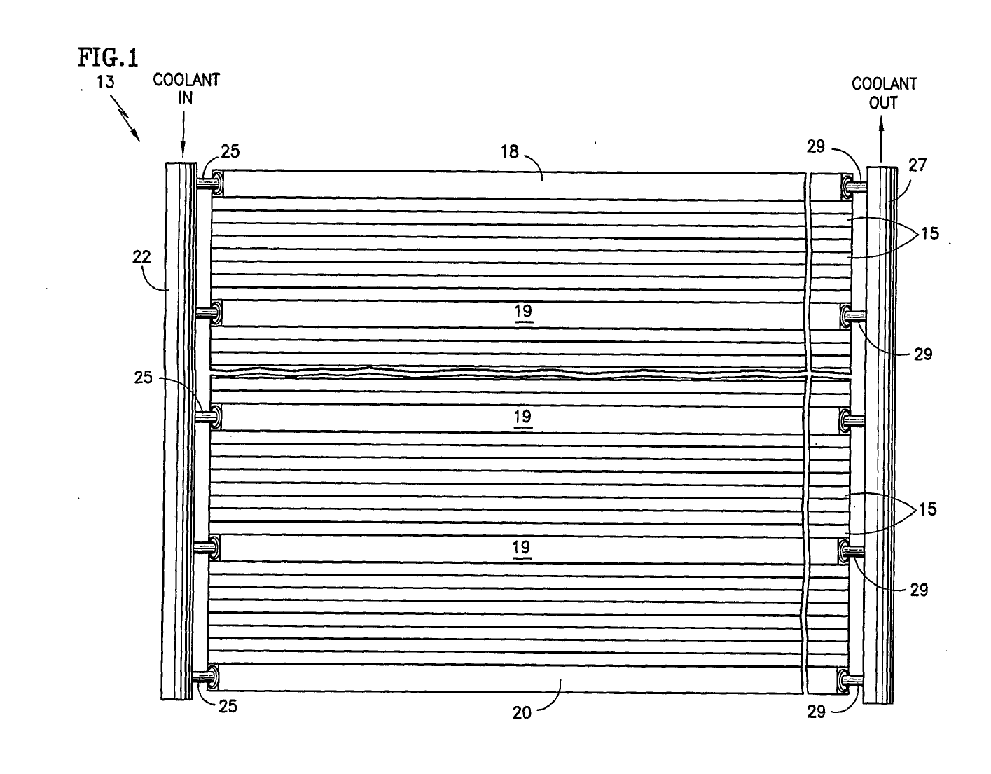

### MODE(S) OF IMPLEMENTATION

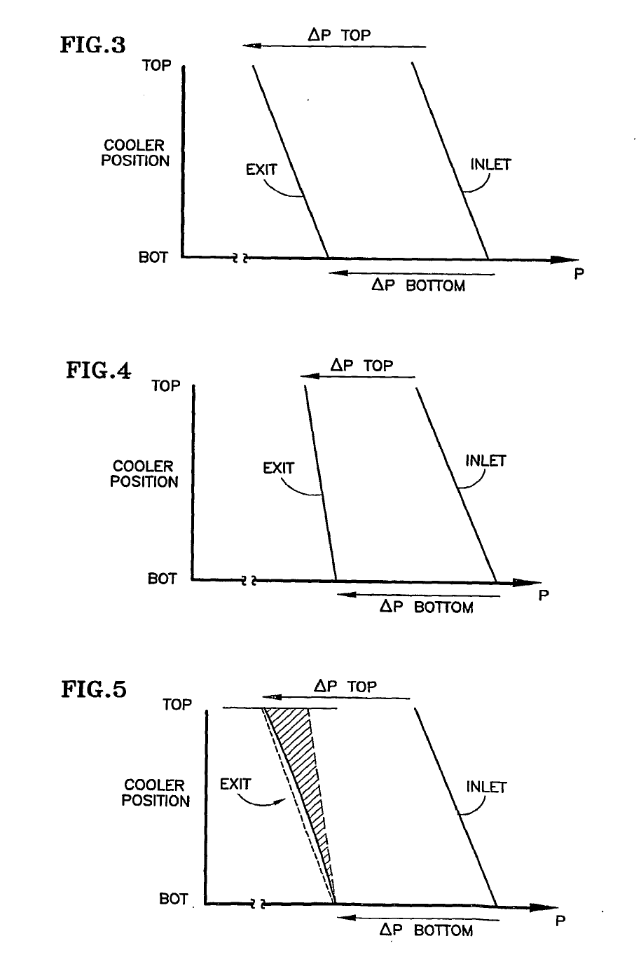

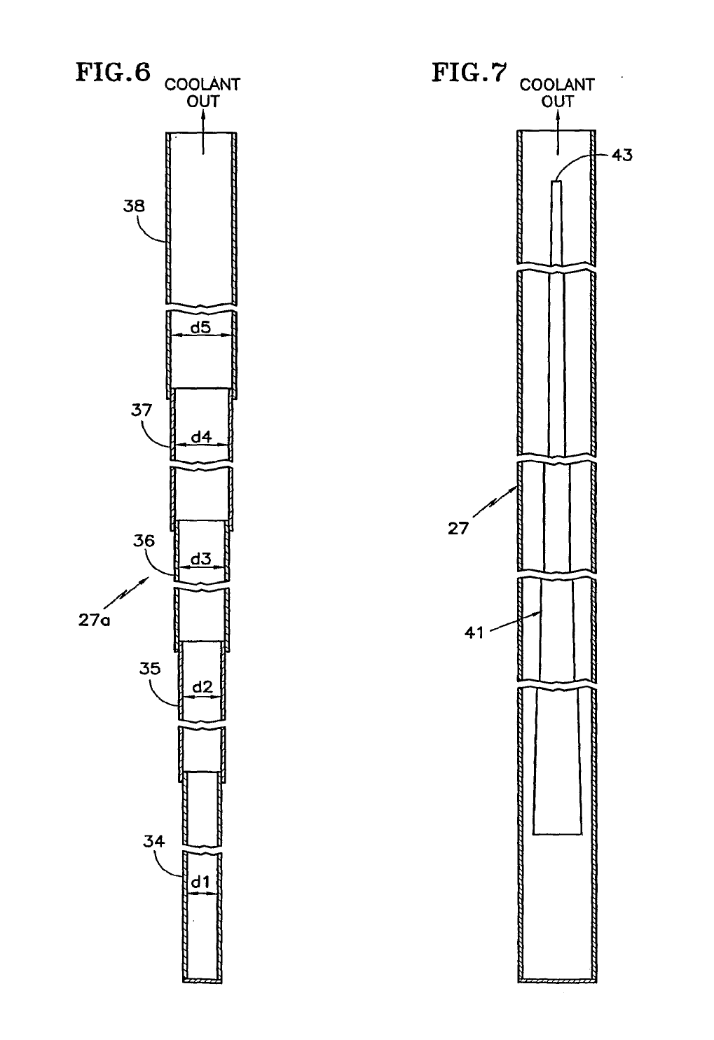

One manner of implementing the improvement herein is illustrated in FIG. 6. Therein, a coolant outlet manifold 27 comprises a plurality of segments 34-38 of pipe having successively larger diameters d1-d5 proceeding from the bottom of the manifold 27a. Segment 34 may be fluidically connected to on the order of 27% of the coolers; the segment 35 may be fluidically connected to on the order of 15% of the coolers; the segment 36 may be connected to on the order of 11% of the coolers; the segment 37 may be fluidically connected to on the order of 15% of the coolers; and the segment 38 may be fluidically connected to on the order of 30% of the coolers. The embodiment of FIG. 3 will provide substantially identical mass flow through all of the coolers, the mass flow variations from nominal ranging between about 5% below nominal flow to about 10% above nominal flow.

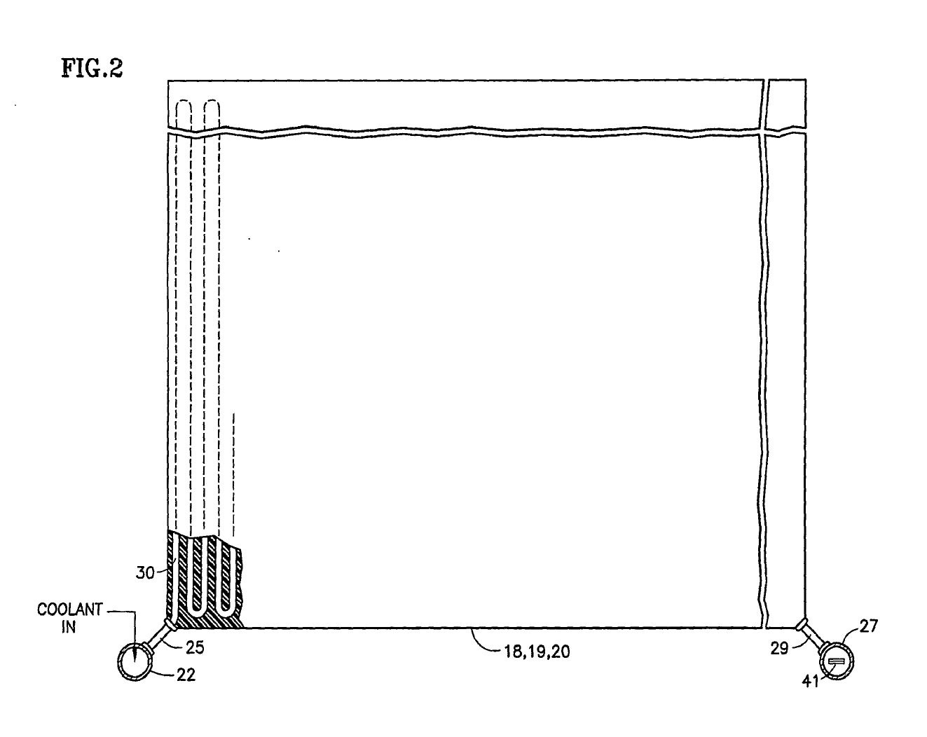

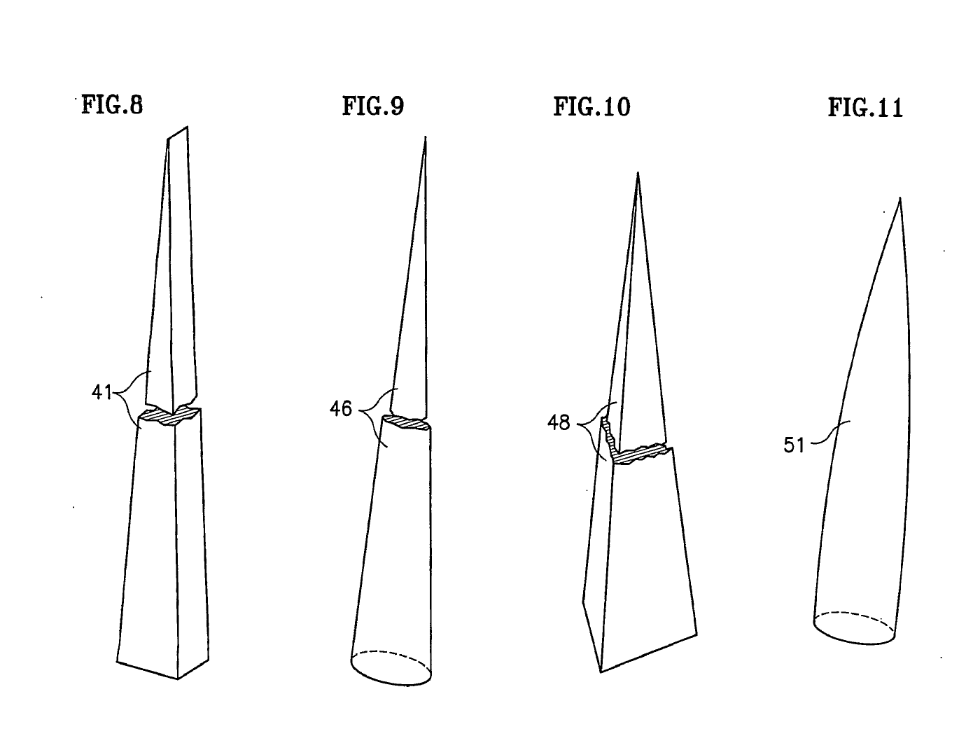

Another embodiment of the invention is illustrated in FIGS. 7 and 8 wherein the coolant outlet manifold 27 has an insert 41 therein. The insert 41 is a trianguloid which may be slightly truncated at the top 43 thereof, or as illustrated in FIG. 8 need not have any significant truncation. The horizontal scale in FIG. 8 is greatly exaggerated compared to the vertical scale, for clarity in illustration. The trianguloid insert 41 is shown (not to scale) in the coolant outlet manifold 27 in FIG. 2.

Variations on the embodiment of FIGS. 4 and 5 include a conical insert 46 illustrated in FIG. 9 and pyramidal insert 48 shown in FIG. 10.

A further improvement herein relates to further discoveries concerning the frictional pressure losses in a two-phase coolant outlet manifold for a liquid electrolyte fuel cell. The frictional pressure losses from the two-phase flow do not increase linearly along the height of the coolant exit manifold, but the rise in frictional pressure losses has a lower slope near the bottom of the coolant outlet manifold and a somewhat steeper slope near the top of the coolant outlet manifold. That is to say, a plot of frictional pressure losses as a function of height of the coolant exit manifold is not linear, but is slightly concave in the direction of higher pressure. Therefore, the improvement may be implemented to achieve even greater consistency of mass flow among all of the cooler plates by using a rotund trianguloid, conoid or pyramid. A rotund conoid 51, for instance, is shown in FIG. 11 with horizontal exaggeration (for clarity).

Other shapes of manifolds and manifold inserts may be used within the purview of the improvement herein. For instance, the embodiment of FIG. 6 could be a single pipe having a smoothly increasing diameter. The trianguloid, conoid, pyramid or obtuse versions thereof could be stepped instead of smooth, if desired. The improvement may be utilized in fuel cell power plants in which the connection with tubing at any point along the coolant inlet manifold and the coolant outlet manifold may connect such particular point on a coolant manifold to more than one cooler plate. For instance, a tube connected at any point of one of the manifolds may have a Y or T arrangement so as to provide fluid communication with two cooler plates.

1. A fuel cell power plant comprising:
a plurality of liquid electrolyte fuel cells (15);
a plurality of cooler plates (18-20) having passageways leading from a cooler inlet of each plate to a cooler outlet of each plate, said cooler plates being disposed horizontally interspersed between said fuel cells in a stack, there being a plurality of fuel cells disposed between each of said cooler plates except those of said cooler plates which are at the top and bottom of the stack;
a vertical coolant inlet manifold (22), each of said cooler plates being fluidically connected by corresponding tubing (25) to a corresponding position of said coolant inlet manifold in dependence upon the height of the corresponding cooler plate in said stack;
a vertical coolant outlet manifold (27), each of said cooler plates being fluidically connected by tubing (29) to a corresponding position of said coolant outlet manifold in dependence upon the height of the corresponding cooler plate in said stack;
characterized by:
said coolant outlet manifold having a coolant flow cross sectional area which varies increasingly from near the bottom of said coolant outlet manifold to near the top of said coolant outlet manifold.

2. A fuel cell power plant according to claim 1 further characterized in that:
said coolant outlet manifold (27) is cylindrical with increasing internal diameter from the bottom thereof to the top thereof.

3. A fuel cell power plant according to claim 1 further characterized in that:
said cross sectional flow area increases in steps.

4. A fuel cell power plant according to claim 1 characterized in that:
said cross sectional flow area increases substantially uniformly as a function of position along said coolant exit manifold.

5. A fuel cell power plant according to claim 1 further characterized in that:
the increase in cross sectional flow area of said coolant outlet manifold (27) is linear.

6. A fuel cell power plant according to claim 1 further characterized in that:
the increase in cross sectional flow area of said coolant outlet manifold (27) is non-linear.

7. A fuel cell power plant according to claim 1 further characterized in that:
the increase in cross sectional flow area is created by means of an insert (41, 46, 48, 51) within said coolant outlet manifold (27) around which the coolant will flow, said insert having a cross section near the bottom of said coolant outlet manifold that is larger than its cross section near the top of said coolant outlet manifold.

8. A fuel cell power plant according to claim 7 further characterized in that:
said insert (41) is a trianguloid.

9. A fuel cell power plant according to claim 7 further characterized in that:
said insert (41) is a rotund trianguloid.

10. A fuel cell power plant according to claim 7 further characterized in that:
said insert (46) is a cone.

11. A fuel cell power plant according to claim 7 further characterized in that:
said insert (46) is a conoid.

12. A fuel cell power plant according to claim 7 further characterized in that:
said insert (58) is a rotund conoid.

13. A fuel cell power plant according to claim 7 further characterized in that:
said insert (48) is a pyramid.

14. A fuel cell power plant according to claim 7 further characterized in that:
said insert (48) is a pyramoid.

15. A fuel cell power plant according to claim 7 further characterized in that:
said insert (48) is a rotund pyramoid.
